(19) United States
(12) Patent Application Publication
(10) Pub. No.: US 2018/0258683 A1
(43) Pub. Date: Sep. 13, 2018

(54) Truck Hopper Gate Opener

(71) Applicant: John Wellman, Hampton, MN (US)

(72) Inventor: John Wellman, Hampton, MN (US)

(21) Appl. No.: 15/618,743

(22) Filed: Jun. 9, 2017

Related U.S. Application Data
(60) Provisional application No. 62/342,337, filed on May 27, 2016.

(51) Int. Cl. E05F 15/655; B60P 1/56

(52) U.S. Cl. CPC E05F 15/655; E05F 15/611; E05Y 2900/516; B60P 1/56

(57) ABSTRACT

A truck hopper gate opener and method of its use are described. The opener includes a static base mounted to a floor or an industrial cart. Pivotally engaged to the base is a frame which includes an articulate arm to provide horizontal motion and a slide/track assembly to provide vertical motion to a rotary motor pivotally engaged thereto. The rotary motor includes a gate opener interface in the form of a clamp or socket configured to couple with a gate opening mechanism of a truck hopper gate, whereby when appropriately positioned and engaged the rotary motor is activated and turns the gate opening mechanism and opens the truck hopper gate.

### RELATED APPLICATIONS

This application claims the benefit of U.S. Provisional Application No. 62/342,337, filed Jun. 10, 2017 the entire contents of which are incorporated herein by reference.

### FIELD OF THE INVENTION

The present disclosure relates to the field of hopper bottom truck trailers, such as grain trucks or other types of trailers or vehicles for carrying and delivering bulk commodities. Such hoppers typically have one or more slide gates or other types of access portals at the bottom of the hopper for unloading of the bulk commodity contained therein. The hopper gate is typically opened via the use of a hand crank engaged to a rack and pinion assembly of the sliding plate (or plates) of the gate. Embodiments of the present disclosure provide a safer and more efficient mechanism for actuation of the crank when opening and closing a hopper gate.

### SUMMARY

Bulk commodity vehicles and/or trailers include hoppers equipped with one or more sliding or other type of gate that opens and closes the discharge opening of the hopper. Typically, sliding gates operate on a rack and pinion mechanism, where a rotational motion is applied to a pinion gear, which engages a rack in order to laterally (or otherwise) move the gate open and closed. Gates must be open to discharge the contents of a hopper, and closed before the hopper is re-loaded.

Often the task of opening and closing the hopper gate is performed manually by an operator using a pry bar or other hand tool to rotate the pinion via a handle or engagement shaft. It is a common occurrence, however, that slide gates may be difficult to open and close for a variety of reasons such as poor maintenance of the slide gates, product having gotten wedged or trapped in the slide gate mechanism, etc.; the result being that the slide gate may bind or jam upon attempting to open or close the gate. In such instances, workers often find that the slide gates resist manual opening and closing, resulting in personal injury to the workers attempting to open the gate as well as potential damage to equipment.

The truck hopper opener described in this application is designed to mechanically open most truck hopper bottom trailers that have a rack and pinion slide gate type of unloading. This is accomplished by means of a powered rotary motor that is attached to a frame. The frame can be a fixed mount assembly or mounted on wheels to make it portable. The frame can be further mounted on a track to ease the movement of the frame in parallel with the truck. In all embodiments the opener as describe herein provides a safe and efficient mechanism for operating truck hopper gates, and which provides a marked improvement over manual actuation of a gate.

### BRIEF DESCRIPTION OF THE DRAWINGS

FIG. 1 is a perspective view of an embodiment of the gate opener that is part of a fixed mount assembly.

FIG. 2 is a perspective view of an embodiment of a gate opener that is made portable by mounting the opener to a heavy duty cart.

FIG. 3 is a side view of the gate opener shown in FIG. 2.

FIGS. 4-6 are a series of top down views of the gate opener shown in FIG. 2, which illustrate the manner in which the multi-hinged arm allows the gate opener interface (e.g. a socket) to be articulated in three directions.

FIGS. 7-10 are a series of side views showing the manner in which the gate opener may be positioned and then subsequently articulated for precise alignment of the gate opener interface with the gate opening mechanism (handle) of the truck hopper.

FIG. 11 is a side view of an embodiment of the gate opener equipped with a break-away coupling along the drive shaft of the gate opener interface.

### DETAILED DESCRIPTION

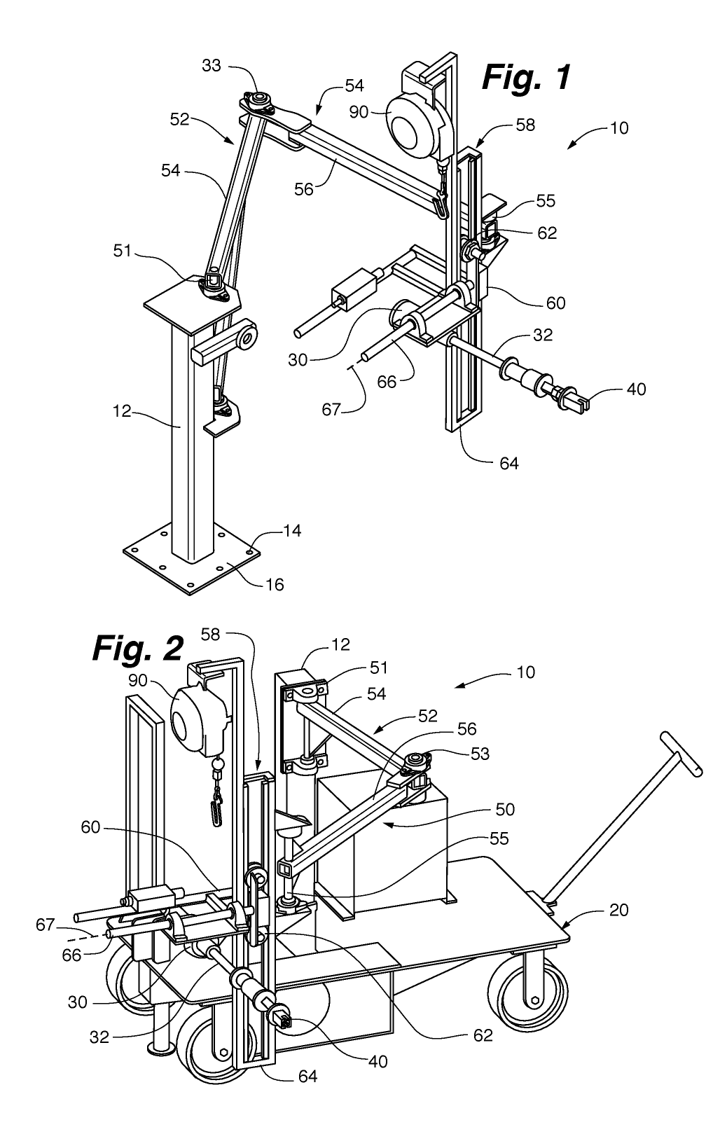

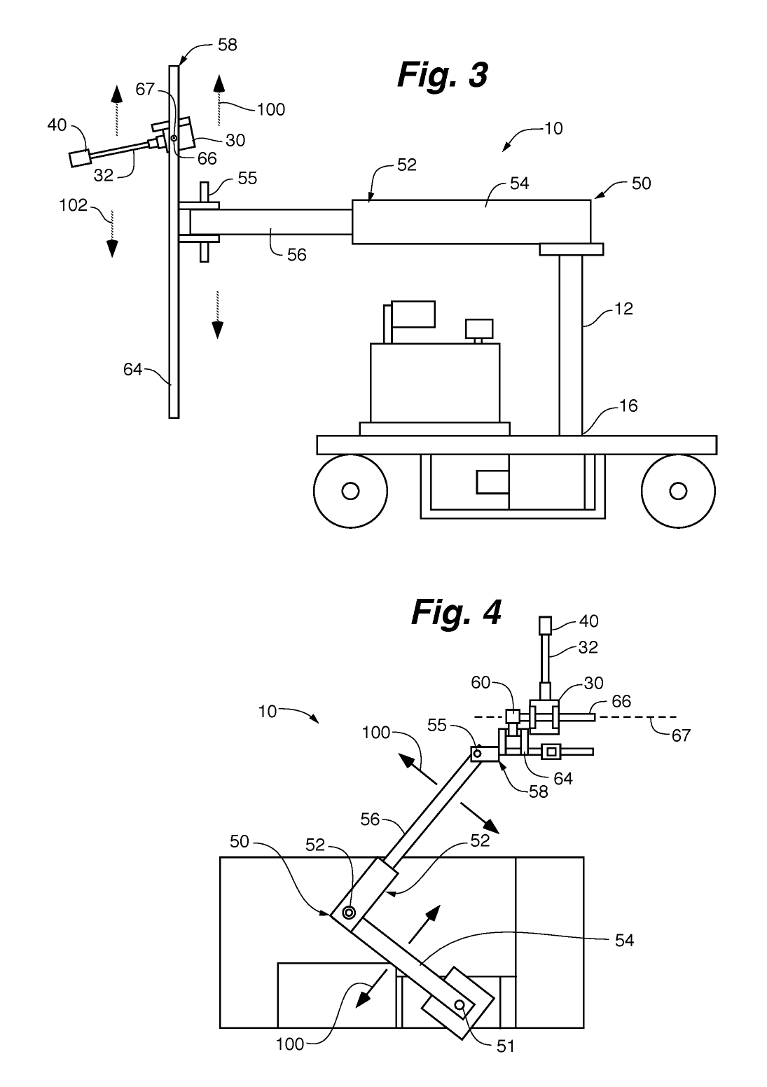

Turning to FIGS. 1 and 2, embodiments of a truck hopper gate opener 10 are shown. In the embodiment of FIG. 1, the opener 10 includes a static base member 12, which in use, would be bolted or otherwise secured to a floor or other surface via bolt holes 14 along its base 16 to provide the device 10 with a stable mount from which the device may be operated. In an alternative embodiment, such as is shown in FIG. 2, the device 10 includes an industrial cart 20 upon which the base 12 is secured. The cart 20 allows the device an equivalent stable platform from which it may be operated, but one that also allows the opener 10 to be moved to different points of operation as may be desired.

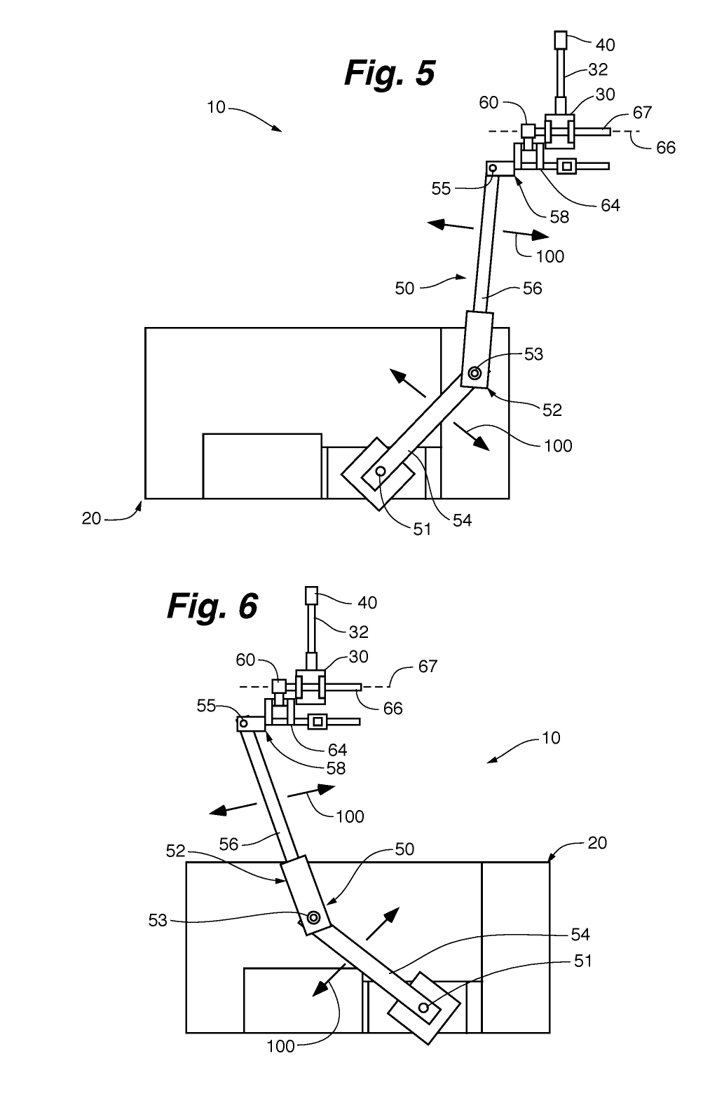

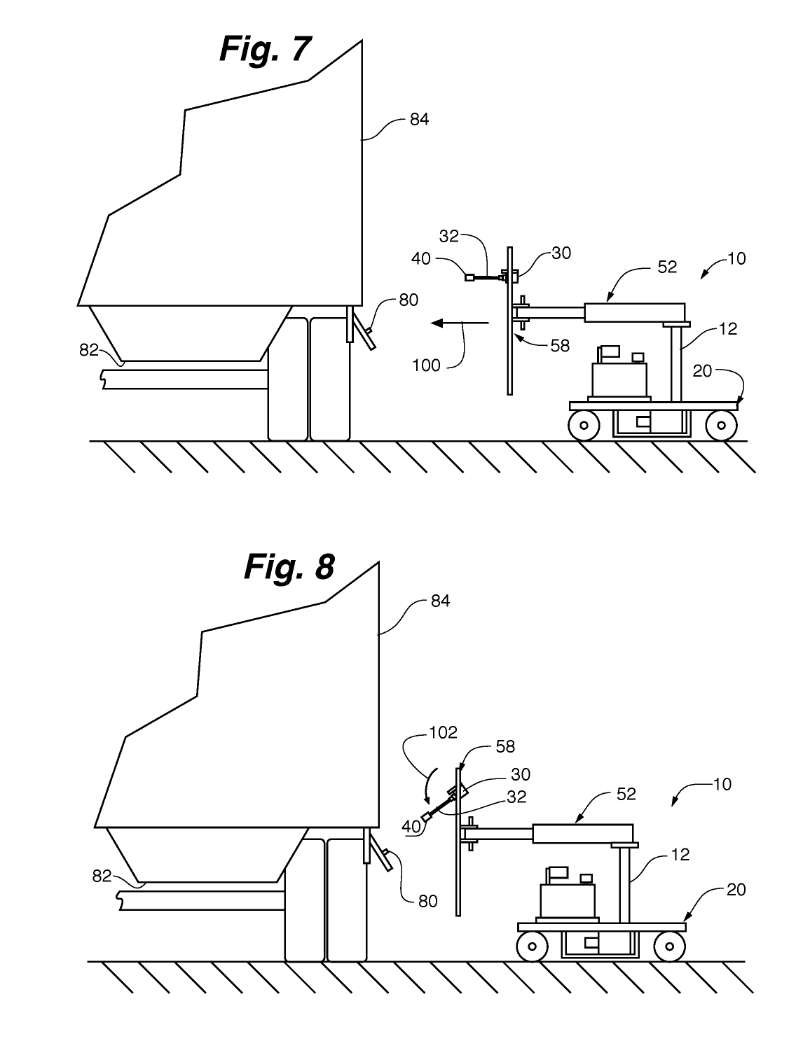

In both embodiments however, the opener 10 is comprised primarily of a powered rotary motor 30, a gate opener interface 40 and an articulate frame 50. The powered rotary motor 30 drives the gate opener interface such as a clamp or socket 40 via a drive shaft 32. The motor 30 is attached to the articulate frame assembly 50, which by its articulation, allows the motor 30 and socket 40 to be moved to nearly any location and orientation adjacent to the cart 20 (or base 12, such as in the case of the embodiment shown in FIG. 1) in the manner shown in FIGS. 3-6.

The frame 50 comprises an articulate arm 52 and a slide/track assembly 58. The articulate arm 52 has the capability to move the powered rotary motor 30 from side to side, in and out relative to the base 12; or in other words to provide the rotary motor 30 with movement on a horizontal plane. Slide/track assembly 58 mounted on the end of the articulate arm 52 provides the rotary motor 30 with up and down motion relative to the base 12; or in other words provides a range of motion along a vertical plane. Arrows 100, 102, provided in FIGS. 3-11 illustrate the possible directions of motion that the frame 50 is capable of providing the motor 30 via articulation of the frame 50.

As is shown in the various figures, the “in-and-out” motion (or “to and from” motion relative to the base 12) as well as some degree of “side to side” movement of the motor 30 is accomplished using the articulate arm 52 secured to the base 12 at a first pivot assembly 51. The arm 52 as shown is a multi-hinged arm and has a first arm portion 54 that extends from the first pivot assembly 51 to a second pivot assembly 53. A second arm portion 56 extends from the second pivot assembly 53 to a third pivot assembly 55. In some embodiments the multi-hinged arm 52 may be comprised of more or less arm portions and pivot assemblies to provide varying degrees of articulation and flexibility.

Pivotally engaged to third pivot assembly 55 is the vertical slide/track assembly 58 to which the rotary motor 30 is slideably engaged via a bracket assembly 60. The vertical slide/track assembly 58 provides the previously mentioned “up-and-down” movement of the rotary motor 30 and socket 40 relative to arm assembly 52. The rotary motor 30 is attached to and supported by a bracket assembly 60 which has at least two bearings members (or wheels) 62 rollingly or slideably engaged within a vertical track or rail 64 defined by the vertical slide/track assembly 58. The bearings 62 slide or roll within the track 64 to provide the rotary motor 30 with the desired up-and-down movement, which is limited only by the length of the track 64.

As shown in FIGS. 1-2, mounted atop the slide/track assembly 58 is a tool balancer 90. The tool balancer 90 is engaged to the bracket assembly 60 when in use. This acts to support the bracket assembly 60 within the slide/track assembly 58 and provide the bracket assembly 60 with a zero-gravity effect to allow the bracket assembly 60 (and more importantly the rotary motor 30) to be moved with relative ease relative to the track 64 when being manipulated or repositioned by an operator, and to stay in the position that it is left in when no longer being moved. The tool balancer 90 may comprise a coiled spring, cable or other mechanism to provide a counter balancing force to the weight of the bracket assembly 60 and associated components such as the rotary motor 30, etc.

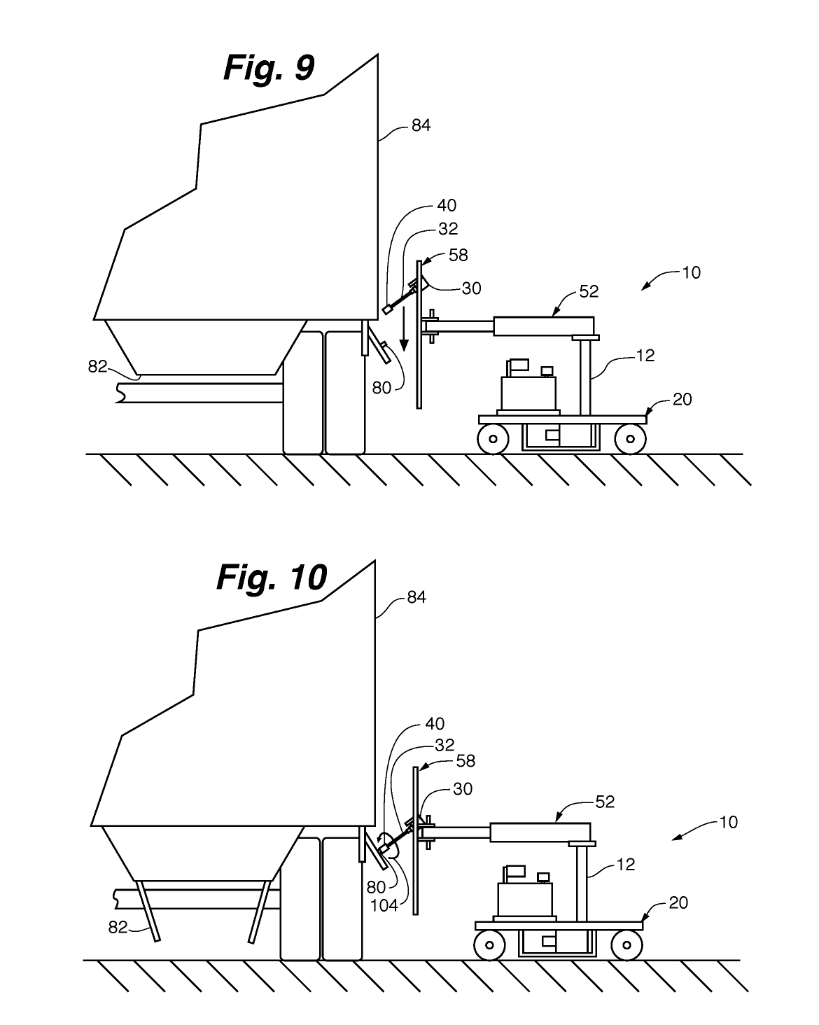

In a preferred embodiment, the bracket assembly 60 includes a pivot support member 66 upon which the rotary motor 30 is held. In some embodiments the rotary motor 30 is rotatable about the pivot support member 66. In some embodiments the rotary motor 30 is fixed to the pivot support member 66, which is rotatable about its axis 67 to angle the motor 30 in the desired manner. In either embodiment, the rotary motor 30 and more significantly the drive shaft 32 and socket 40—may be tilted or swiveled (see arrows 102 in FIGS. 3 and 8) about the axis 67 of the pivot support member to any desired angle relative to the track 64, thereby allowing the drive shaft 32 to be oriented at the proper angle of alignment so as to match up the socket 40 with the opening mechanism 80 of a hopper gate 82 of a vehicle or trailer 84 such as in the manner depicted in FIGS. 7-10.

Turning to the sequence of images shown in FIGS. 7-10, here the embodiment of the truck hopper opener 10 as depicted in FIG. 2-6 is shown in its environment of use. When properly utilized, the opener 10 is moved into positioned roughly adjacent to a hopper gate 82 of the trailer 84 via the cart 20, such as in the manner shown in FIG. 7.

Note, that while the frame 50 is oriented extending from a side of the cart 20 in FIGS. 3-6, in FIGS. 7-11 the fram is oriented to extend across and over the front (or rear) of the cart 20. The orientation of the frame 20 may be in any direction relative to the cart 20 or the static base 12.

By articulation and manipulation of the arm assembly 52, and slide/track assembly of the frame 50, such as in the manner shown in FIGS. 3-6, the rotary motor 30, drive shaft 32, and socket 40 are roughly aligned with the opening mechanism 80. Once the opener 10 is in proximity of the opening mechanism 80, the rotary motor 30 may be tilted to match the angle defined by the opening mechanism 80, such as in the manner shown in FIG. 8. The socket 40 is then moved into final position and is engaged to the opening mechanism 80, such as in the manner depicted in FIGS. 9-10. Once the socket 40 is engaged to the opening mechanism 80, the rotary motor 30 is activated, and applies rotational force (torque indicated by arrow 104) to the drive shaft 32 thereby turning the socket 40 and the opening mechanism 80; resulting in the gate 82 moving from a closed position to an open position shown in FIG. 10. When it is desired to close the gate 82 the rotary motor 30 is activated in the reverse direction to close the gate 82.

Note, that the gate 82 depicted in FIG. 10 is depicted as a pair of downward opening plates. This depiction is solely for the purpose of showing the gate 82 in a clearly “open” position. Gate 82 may be any type or configuration of gate such as an industry standard slide gate assembly.

The socket 40 is configured to engage industry standard opening mechanisms 80. If for some reason the socket 40 is not appropriately sized or shaped to properly engage a given handle, shaft or crank configuration of a specific opening mechanism; any of a variety of adapters may be is used to attach the socket 40 to the trailer's opening mechanism 80.

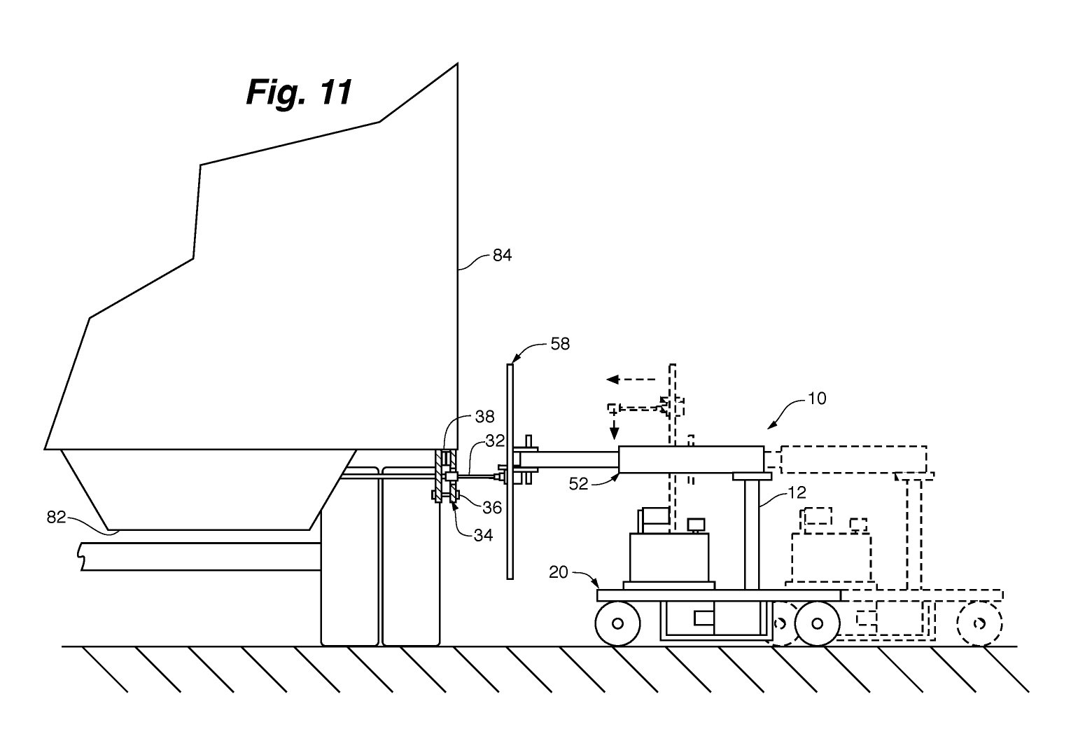

Another feature of the present opener 10 that may provide an even greater level of efficiency and safety is the use of a “break-away” coupling 34 along the drive shaft 32 or as part of the interface 40, such as is shown in FIG. 11. Such a break-away coupling 34 may be mechanical, such as through the use of a shear pin 36; magnetic, such as through the use of a magnetic couplings 38, or some combination of both. The “break-away” coupling 34 allows the shaft 32 to “break” at the location of the coupling 34 in the eventuality that the truck/trailer 84 moves out of alignment during the opening or closing process discussed above. This allows the shaft 32 to break without damaging the shaft 32 or other components of the opener 10 (or trailer 84) while also minimizing the possibility of injury to the operator of the opener 10, such as might otherwise occur from components being broken or dragged as a result of the trailer's movement.

This break-away feature may also be inserted in the middle of the drive shaft 32, such that the drive shaft 32 is divided into two separate components. The two components of the drive shaft 32 are each attached to a connection plate, with the plates of the two components being secured together by one or more shear pins 34, magnetic couplings 38, or both. The drive shaft components may further engage through the use of a socket in one component receiving a butt end of the other component. The connection plates ensure consistent rotation of the drive shaft, while allowing the shaft to break at the connection plate if a trailer 84 were to be moved while the drive shaft coupling 40 is connected to the opening mechanism 80.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A truck hopper gate opener comprises:
a static base, a frame pivotally engaged to the static base, a rotary motor pivotally engaged to the frame, and a gate opener interface coupled to the rotary motor;
the frame providing the rotary motor with movement along both a horizontal plane and a vertical plane;
the gate opener interface constructed and arranged to mechanically engage a gate opening mechanism of a truck hopper gate, when thusly engaged the rotary motor rotating the gate opener interface and gate opening mechanism to move the truck hopper gate to an open position.

2. The opener of claim 1, further comprising a cart, the static base being engaged to a surface of the cart.

3. The opener of claim 1, wherein the frame comprises an articulate arm and a slide/track assembly, the articulate arm extending from the static base, the slide/track assembly being pivotally engaged to the articulate arm, the articulate arm providing the rotary motor and the slide/track assembly with the movement along the horizontal plane, the slide/track assembly providing the rotary motor with the movement along the vertical plane.

4. The opener of claim 4, wherein the articulate arm comprises a first arm portion and a second arm portion, the first arm portion extending from a first pivot assembly mounted to the static base to a second pivot assembly, the second arm portion extends from the second pivot assembly to a third pivot assembly, the slide/track assembly being pivotally engaged to the second arm portion via the third pivot assembly.

5. The opener of claim 3, further comprising a bracket assembly, the bracket assembly comprising a pivot support member and at least two bearing members, the rotary motor being engaged to the pivot support member, the slide/track assembly defining a vertical track, the at least two bearing members rollingly engaged to the vertical track.

6. The opener of claim 1, further comprising a drive shaft, the drive shaft extending from the rotary motor to the gate opener interface.

7. The opener of claim 6, wherein the gate opener interface defines a socket, the socket configured to receive and engage the opening mechanism of the truck hopper gate.

8. The opener of claim 6, wherein the drive shaft comprises a break-away coupling.

9. The opener of claim 8, wherein the break-away coupling is selected from the group consisting of a coupling comprising a sheer pin, a magnetic interface, and any combination thereof.

10. A method for opening a slide gate of a truck hopper comprising:
providing a truck hopper gate opener, the truck hopper gate opener comprising:
a static base, a frame pivotally engaged to the static base, a rotary motor pivotally engaged to the frame, and a gate opener interface coupled to the rotary motor, the frame providing the rotary motor with movement along both a horizontal plane and a vertical plane;
moving the rotary motor to a position adjacent to an opening mechanism of the slide gate;
pivoting the rotary motor to align the gate opener interface with the opening mechanism;
mechanically engaging the gate opener interface to the opening mechanism; and
activating the rotary motor to apply torque to the gate opener interface and the opening mechanism resulting in the slide gate of the truck hopper to be opened.
